(19) United States
(12) Patent Application Publication
(10) Pub. No.: US 2015/0312333 A1
(43) Pub. Date: Oct. 29, 2015

(54) Method and System for Optimizing and Distributing User Activity Data Processing in a Multi-User, Multi-Location Environment

(71) Applicant: PartyGaming IA Limited, Hamilton (BM)

(72) Inventors: Suyash Motarwar, Hyderabad (IN); Neil Hussey, Gibraltar (GI); Ross McQuater, Gibraltar (GI); Hymavathy Routhu, Hyderabad (IN); Gaurav Duggal, Hyderabad (IN); Deepesh Kumar Singh, Kanpur (IN)

(73) Assignee: PartyGaming IA Limited, Hamilton (BM)

(21) Appl. No.: 14/483,920

(22) Filed: Sep. 11, 2014

Related U.S. Application Data
(63) Continuation-in-part of application No. 14/265,357, filed on Apr. 29, 2014.

(51) Int. Cl. H04L 29/08

(52) U.S. Cl. CPC H04L 67/1008; H04L 67/24; H04L 67/18

(57) ABSTRACT

A method and system for are provided for optimizing and distributing data processing and resources in a multi-user, multi-location digital environment. User activity and user states are compiled and analyzed for each location where the user is present. User event processing may include distributing event data to one or more user state processors, choosing the optimum target processor, and filtering user event data to eliminate duplicate or unnecessary transmissions between processors that are hosted on one or more servers. Process intensive tasks, such as analyzing and transmitting user events, generated by user activity and user state changes, may be implemented using threads in an asynchronous processing environment, wherein the processors are horizontally scalable.

This application is a continuation-in-part of U.S. patent application Ser. No. 14/265,357, filed on Apr. 29, 2014.

### BACKGROUND OF THE INVENTION

1. Field of the Invention

The present invention is directed to a computer-implemented method and system for optimizing and distributing user activity data processing in a multi-user, multi-location environment.

2. Description of the Related Art

Certain digital environments may bring together multiple users, up to about 100 users or more, of varying experience levels and skill in a common activity. The users may congregate in multiple locations up to about 20 locations or more, with clusters of users at each location that are engaged with each other. The users often progress through one or more rounds of the activity. Although the activity is common to the users, the environment may be competitive, where each user may be self-interested and seeking a greater advantage in the activity.

Within those environments, less experienced users may not be as well-versed in the intricacies of the environment and may be at a disadvantage as compared to other users. For purposes of this application, less experienced users may be referred to as “novices” and more experienced users may be referred to as “experts,” and the focus is more on the experience disparity than the actual experience level of the users.

Experts may increase their advantage if there are fewer active users at the location or if there are active novices at the location. In the later case, an expert may reserve a place at a location and remain inactive until there are active novices at the location.

Alternatively, an expert may monitor locations to determine the types of users that participate at each location. The expert then may target a location where one or more novices previously were active and where additional novices may to join. For example, novices may be more risk averse and, therefore, may choose locations that are lower risk, lower reward, which may be likely to have other novices. This strategy may be upset by experts targeting those very locations. Though the novice's losses may be small, they may accumulate over time to be a substantial amount of gain for the experts.

Over time, these losses may diminish a novice's desire to return to the environment, thereby decreasing the overall population of users and diminishing the overall activity in the environment. It may be desirable to monitor user activity to identify experts who may be taking advantage of other users and to take corrective action.

Some computer-implemented environments may accommodate over 1,000 users participating in the activity, (accounting for users participating in multiple locations) and may accommodate over 1,000 locations. The locations may be hosted on multiple servers, housed in different physical places, processing high-volume and fast paced activity. Thus it may be impossible for an administrator to monitor and to correct user abuses in the environment. Also, the volume of user events created, because of the increase in the number of users participating in the activity and the number of locations available, may soon overwhelm system resources and processing capability.

A method and system are needed to address the disadvantages described above.

### BRIEF SUMMARY OF THE INVENTION

In one aspect, a method for optimizing and distributing user activity data processing in a multi-user, multi-location digital environment may include the steps of hosting a plurality of virtual locations, identifying for each user, locations where they have initiated a user instance, and determining, for each user, a user instance state at each location. User instance states are transmitted via at least one location events broadcaster to at least one of a plurality of global state managers, optimizing and distributing the user instance states data load among at least two servers.

Additionally, optimization may be achieved by comparing each user state with a cached user state, transmitting only those user states that are different than the cached user states. The reduction in transmissions of user instance states may result in an increase in total system capacity of up to about 80%.

User instance states may be compiled and analyzed by global state managers, to determine which users are mixed-state mode, wherein mixed-state users have an active user instance at a first location and inactive user instance at a second location.

Identification of the mixed-state users and one or more locations of their inactive user instances are delivered to the servers hosting those locations. Additionally, user state may be analyzed with regard to a user's indication of a future user instance state preference for one or more locations. State managers may determine if any exception exists that would suspend action against any one or more of the mixed-state users and take action with respect to mixed-state users for which there is no exception, including transmitting a warning to a mixed-state user to remedy the mixed-state status or removing a mixed-state user from one or more inactive locations.

Analysis of the user instance states may be distributed among the plurality of global state managers. In addition, load balancing may be achieved by routing user instance states for a user to a server that is hosting at least one location where the user instance is present.

In this aspect, the multi-user, multi-location digital environment may be implemented using threads in an asynchronous processing environment, processing up to about 2.7 million raw events per hour, with up to about 3,000 locations and at least about 6,000 concurrent user instances.

The location events broadcaster filters user events for the event dispatcher, determines which global state manager is the desired target to receive the user's events, and transmits user events through the location events broadcaster to the target global state manager. In addition, the location events broadcaster removes duplicate or unchanged events before transmitting the data to a global state manager, and the location events broadcaster does not transmit user events that do not change the global state of the user.

The global state managers are horizontally scalable to each additional server beyond the first.

In another aspect, a computer-implemented system for optimizing and distributing user activity data processing in a multi-user, multi-location digital environment, with one or more servers for storing user state and user event data and a user state manager for executing the end decision to keep or remove a user instance from a location. The user state manager may include a state decider for determining what actions to take with respect to a user instance and a state executor for implementing the action determined by the state decider.

Additionally, a location events broadcaster aggregates data for transmission to other system components and one or more global state managers consolidate user instances' states across all locations, for analyzing those states by using a global state calculator to determine the user mode, and for implementing an global state filter in order to minimize or eliminate unnecessary transmissions.

In this aspect, the multi-use, multi-location digital environment may accommodate up to about 3,000 locations with at least about 6,000 concurrent user instances, with one or more servers processing up to about 2.7 million raw events per hour.

These and other features and advantages are evident from the following description of the present invention, with reference to the accompanying drawings.

### BRIEF DESCRIPTION OF THE SEVERAL VIEWS OF THE DRAWINGS

FIG. 1 is a process flow chart illustrating the data analysis method.

FIG. 2A is a high level system diagram of first server components used to execute the method.

FIG. 2B is high level system diagram of second server components used to execute the method.

FIG. 2C is a high level system diagram of the location events broadcaster.

FIG. 2D is a more detailed system diagram of the user state container.

### DETAILED DESCRIPTION

A system and method for analyzing the activity state of a user in a multi-user, multi-location environment and for taking action against a user that seeks to manufacture a competitive advantage over other users are described.

In one example, as described in greater detail below, the system and method may be particularly applicable to a digital gaming environment in which a user can be seated at more than one gaming table at a time. Approximately 50% of all users have seats at more than one gaming table at a time.

In one aspect, the system may employ an identification filter, whereby each user that is active at one or more locations and, at the same time, is present but inactive at one or more second locations is identified as a suspect user.

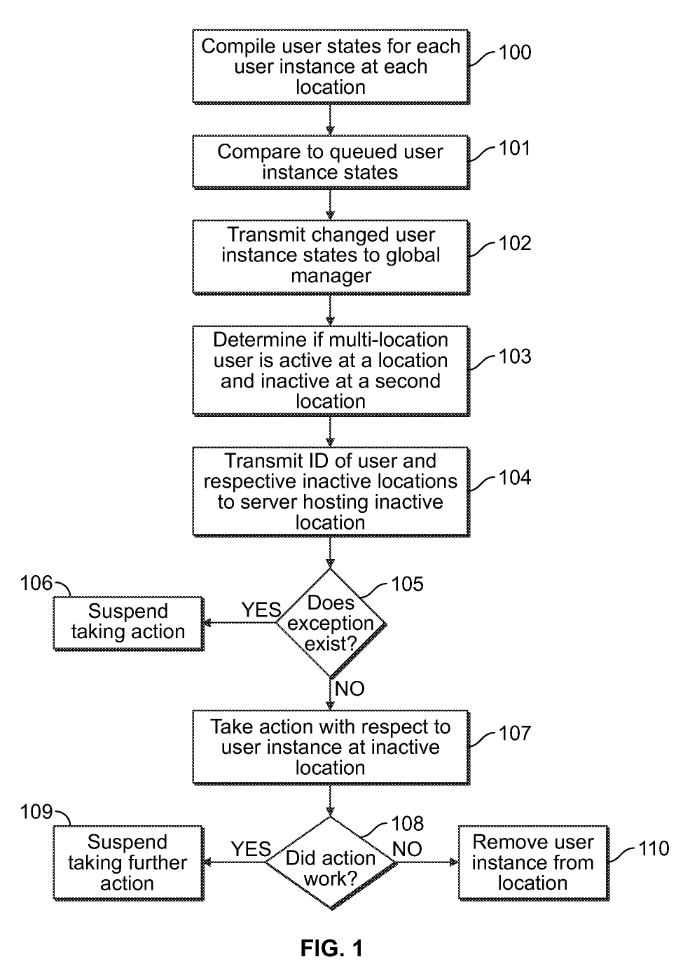

The method and system, however, as shown in FIG. 1 also may recognize that there are permissible justifications 105 for some user inactivity and, therefore, should be able to identify and suspend taking action 106 against those users. Thus, the system may be configured to segregate the actual, suspect users from genuine, non-problematic users.

In addition, technical challenges are magnified more than proportionally when the system is scaled. Yet as described herein, the system maintains real time analysis despite the presence of large numbers of concurrent users. For example, in the virtual gaming case described below, the system may be configured to operate with at capacity of least 100 concurrent users where each user can generate multiple user instances, each at a separate location. In one embodiment, the system may be configured to operate with at least about 6,000 active user instances (includes users with multiple user instances, each at a different location). In this embodiment, if each user instance generates, on average, about five events per hand, the average total is about 30,000 concurrent events that the system analyzes and processes. If the average time between new hands is about 40 seconds and if sampling occurs only once a minute, then the system must be configured to process approximately 2.7 million raw events in an hour. Moreover, data sampling may occur whenever changes in user activity state occur, i.e., data may be pushed to the analytical tool rather than pulled by it at predetermined intervals. In this case data sampling may occur significantly more frequently than once a minute, increasing the number of data points to be analyzed accordingly.

In another embodiment, the system may be stress tested with up to 20,000 user instances.

Identification Filter/Classification Process

There are two parts to the solution of the general problem: (1) identify suspect users and (2) determine what action, if any, should be taken for each of these users. The action may a warning and/or some corrective action to deter future suspect behavior. One example of this process is illustrated in FIG. 1.

Identifying Suspect Users

At a high level, the first step in this process is analyzing each user's current activity to determine whether each user is present at a single location or multiple locations. The system and method are concerned primarily with suspicious behavior from multi-location users; thus only users currently present at more than one location may be pooled for further analysis.

The system then may classify each multi-location user into one of a plurality of subsets based on an aggregation of user instance states. Classification may occur on the basis of the user instances' current state at each location. Preferably, however, the system may classify each user based on the user's preferences, which may indicate a future activity state for a specific location.

In one example, the system may include three subsets or modes for each user, i.e.:

(1) universal inactive mode—In this mode, the user instances are inactive or the user has indicated the intent to be inactive at each location;

(2) all active mode—In this mode, the user instances are active or the user has indicated the intent to be active at each location;

(3) mixed-state mode—In this mode, the user has selected an inactive option, e.g., for some, but not all, locations joined by the user, thus the user has both active and inactive user instances.

In one embodiment, this categorization may classify each user in mixed-state mode as a “suspect” or “suspicious” user. This may be considered the “default assumption.”

The method and system also may recognize one or more exceptions to the default assumption 105 for mixed-state users. For example, even though the user may be inactive at a certain location, there may be system restraints outside of the user's control that are preventing the user from having an active state at that location. One or more of the exceptions may place the user in a “watch-state,” pending resolution of the system restraint.

As long as any of these watch-state exceptions continues to exist, the system may recognize the user's watch-state and not penalize the user for otherwise being in mixed-state mode with respect to the relevant location(s). The system, however, may continue to penalize the user if he or she is in mixed-state mode with respect to other locations to which no watch state exceptions apply 107. For example, a user may have user instances at four locations, including being active at two locations and inactive at two locations. Of the inactive locations, the user may be the only entity present at one location and no watch-state exceptions may apply to the other location. In this situation, the system may recognize the exception to the first inactive location and take no action, but may determine that the user is in mixed-state mode with respect to the second location, triggering the system's corrective actions 107 with respect to that location.

The mode categorization assigned to each user is a dynamic characteristic, such that it may change as each of their user instance states change.

Determining Action to Take

“Action” (which may be corrective or remedial) may vary in each implementation. In one example, action may occur based on the user's current, actual state at each location. It may comprise warning the user and if the user does not take remedial action, e.g., changing to active state at the location or leaving the location, within a predetermined amount of time, then removing their inactive user instance from the location.

In another example, user mode identification also may be determined by the user's indication of future preferences at specific locations. This implementation means that certain users identified as being in mixed-state mode may not face corrective action for locations at which they are scheduled to be inactive, but at which they currently are active.

Technical Implementation

The system can be implemented on a single server that is responsible both for implementation of the digital environment underlying activity and for data analytics, however, preferably the system will use multiple servers. In this case, a user may have user instances at locations hosted on different servers, and the system must be able to analyze user activity and states across all servers.

Each server may include multiple similar components as the other servers, as discussed in greater detail below. Preferably data is pushed from one component to the next, rather than waiting for a destination component to send a request to pull the data, although data transmission requests in that direction also are permissible.

Multiple Servers

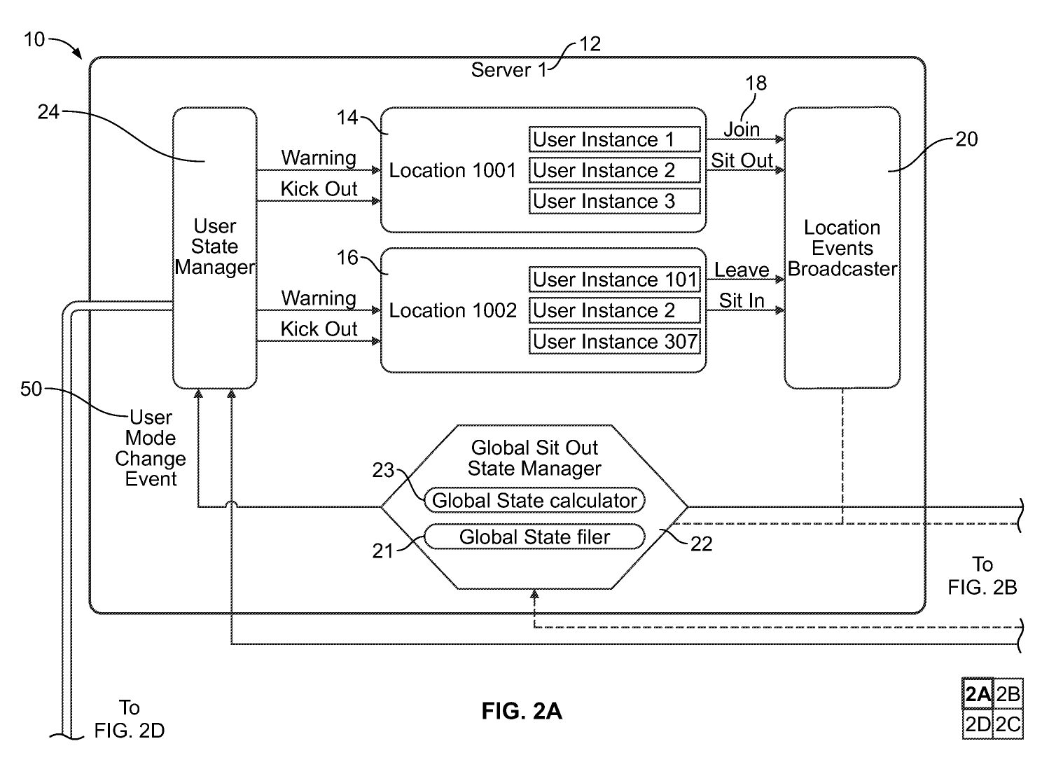

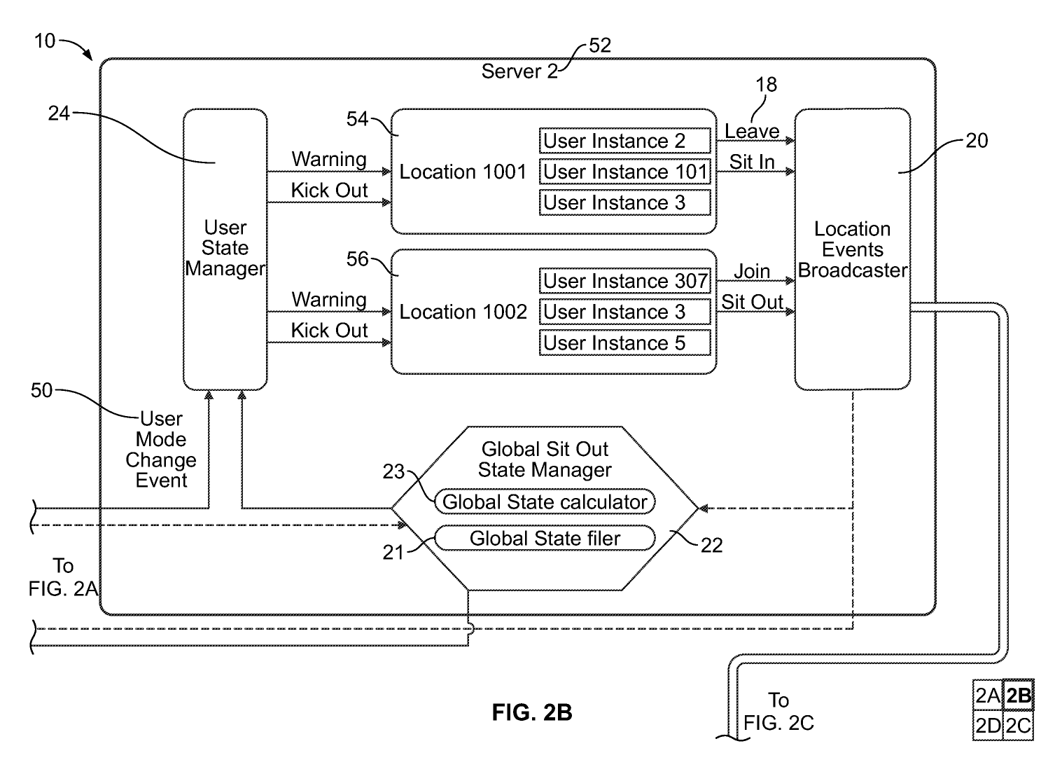

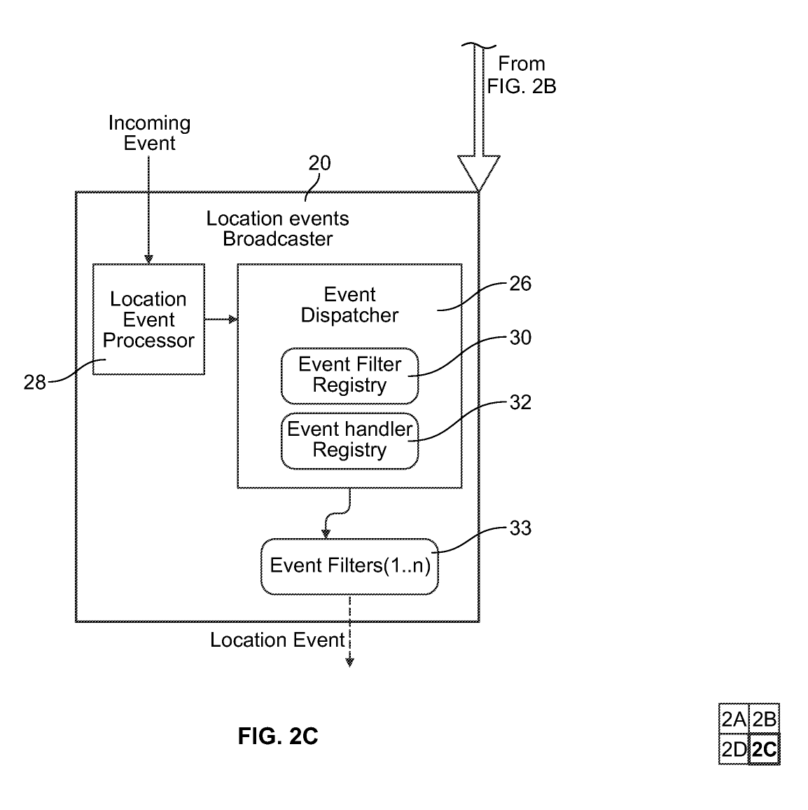

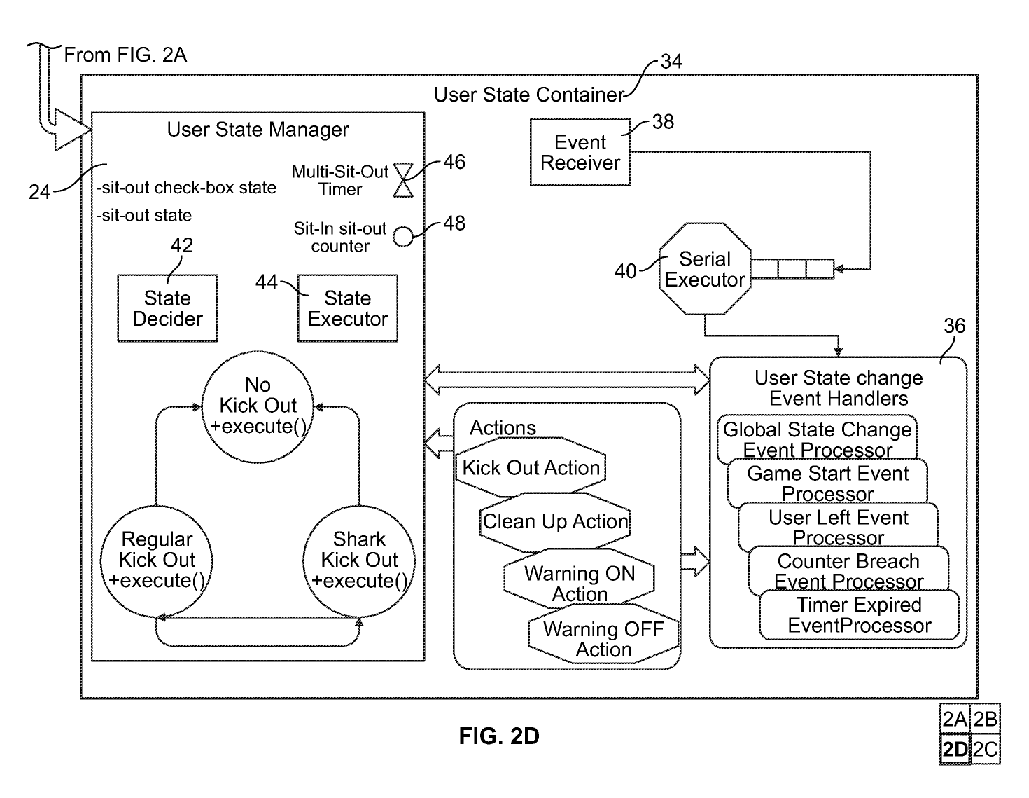

Turning now to FIGS. 2A and 2B, one example of a system diagram is shown, with the system specifically being configured to implement a multi-server, multi-location distributed environment. System 10 may include a plurality of servers, including FIG. 2A first server 12 and FIG. 2B second server 52.

A server for use in system 10 and for execution of the process as disclosed, in the context of a current multi-user, multi-location environment with high-volume and fast paced activity, and also in the context of presently available hardware, preferably should have a processor capable of operating at a speed of at least about two (2) GHz and should have two or more cores. A server for use in the disclosed system and process also should have at least about 3,000 MB of memory. One example of a server usable as a component to system 10 and to execute the process may be a VM server made by VMware with a 3.07 GHz dual core XEON X5675 processor, the server also having 5,835 MB of memory. It will be appreciated that other server configurations also may be used, and that not all servers necessarily must have the same configuration. Evolution in multi-user, multi-location environments and in hardware capabilities may occur without departing from the spirit of the invention as disclosed and claimed.

First server 12 shown in FIG. 2A may host a plurality of locations 14, 16, and second server 52 shown in FIG. 2B may host a separate plurality of locations 54, 56. Each location on each server may be given a unique ID and each user also may have a unique ID, where the user ID may be associated with their user instances at their locations.

Whenever a user logs on to the system, the system may generate a unique hash key in order to trace and keep track of the user's activity throughout the system. In one aspect, the hash key may correspond to the user's ID, since each user ID also is unique, although the hash key may be a separate value entirely. Each hash key may be stored in a list that may be accessible by each of the system components in order to trace, analyze, and manage user activity data.

Locations

In addition to facilitating user activity, each location 14, 16, 54, 56 shown in FIGS. 2A and 2B may maintain the state of each user instance with respect to the current activity.

Each location also may maintain users' preferences with respect to future actions for current user instances. The system may apply a default event state to each user instance, e.g., “active” if no other event state is selected.

At any given time, a user instance state may be determined one of a plurality of event descriptors 18. Exemplary event descriptors may include “join,” “leave,” “active,” and “inactive,” although other descriptors or combinations of descriptors may be possible.

Location data may be stored in a database either integrated into or in communication with a respective server or a plurality of servers in the latter case. While location data may be stored in a database, as some of this data may need to be kept for auditing or recordkeeping purposes, data analysis preferably occurs in memory, as described below.

Location Events Broadcasters

Event descriptors may be transmitted continuously and in real time to a location events broadcaster 20 on each server, which is responsible for aggregating events for transmission to other system components, namely to a global state manager 22.

In one example, each events broadcaster 20 may maintain a local cache of states for each user instance at a location that is resident on its server. To increase system optimization and to reduce the burden on system resources, the events broadcaster 20 may compare each user instance state with its cached states to determine whether there has been any change in user states. The events broadcaster may be configured to transmit only those user events where the user instance status has changed since the last transmission to the global state managers 22. In this example, approximately 40-50% of user instance states may be determined to be redundant or duplicate events and are not transmitted. As a result the system can handle more than twice the load in the same time frame.

Global State Managers

System 10 may include a global state manager 22 on one or more of its servers 12, 52 that is responsible for consolidating a state of the user instances across all locations, for analyzing those states by using a global state calculator to determine the user mode, and for implementing an identification filter in order minimize or eliminate a need for redundant, duplicative, unchanged, or otherwise unnecessary transmissions, as discussed above.

Global state managers 22 may be hosted across all servers 12, 52, which may provide one or more advantages to the system. First, a distributed series of global state managers may guard against a single point of failure with the global state managers. Additionally, the system may reset one or more of the global state managers without interrupting location activity being hosted on each server. Users are not aware that this aspect of the system is offline because it runs in a back-end environment. Considering that a reset may take a few minutes, e.g., about five minutes, the advantage of this distributed configuration becomes apparent. In addition, the load is distributed over all of the servers equally which maximizes resource utilization. This design is horizontally scalable allowing for the addition of serves to handle an increase in user load.

Second, by distributing the global state manager 22 across multiple servers, the system may take advantage of the parallel processing made possible by having multiple CPUs.

In one embodiment, location events broadcasters 20 may transmit events to each server's global state manager 22. Each global state manager then may cross-reference the events with a list of users (e.g., via hash keys) assigned to that global state manager to determine if it is to analyze that user's actions. Preferably, however, the system may distribute user activity according to the server responsible for its analysis prior to transmitting that data.

The system may include load balancing or load optimization to distribute analysis among the multiple global state managers 22 and to prevent any one global state manager from supporting too large a computational load. System load balancing depends on the number of servers and the effort to distribute the load equally among the servers. In one aspect, optimization may include routing events for a user to a server that hosts a location where the user has a user instance, so that the resident location events broadcaster 20 has at least one less event to transmit outside the server. Similarly, if the user is present at multiple locations that reside on a single server, that server should be weighted even more heavily to receive the user's other events. If load balancing did not occur there could be situations where one server is doing all the processing while the other servers are idle. The system performance is directly proportional to the number of servers that are sharing the load.

Additionally or alternatively, optimization may include a counter or other way to determine the number of users being analyzed by each global state manager 22 and may route analysis of the next new user to the global state manager with the lowest load. Other load balancing or optimization techniques also may be employed.

Much like the filtering/load reduction techniques discussed above regarding the location events broadcasters 20, the global state managers 22 may implement local filtering at a global state filter to reduce the amount of data to be transmitted from a global state manager to other system components. For example, each global state manager 22 may maintain a local cache or queue of the modes of its analyzed users. Once the system determines a user mode, the global state manager may compare that mode with the cached copy it maintains for the user. The chance of the user mode remaining the same is equal to ((2̂N)−2)/(2̂N) for N>1 where N is the number of locations where the user has a user instance. Thus if the average user is at three locations at a time, the user mode will not change about 75% of the time. During peak operation the number of user modes being monitored by one global state manager is about 6000/n where n is the number of servers.

The system then may transmit only those user mode events 50 in the case that there is a change in mode for a user, thereby minimizing the number of mode events generated and processed. Between this filtering and that done with respect to the events broadcasters, system 10 may reduce a number of events requiring further analysis by significant amount. For example, these filters may be responsible for reducing the number of events to be processed by between about 70% and about 80%. By implementing one or more of these filters in a distributed network environment, we can boost the system's stress tolerance to about 3 to 5 times the original tolerance. This filtering helps to prevent latency degradation and effectively increases the scalability of the system.

The global state manager 22 also may be configured for a concurrent environment, whereby user-specific and location-specific events preferably are processed sequentially. In other words, the system is configured to determine and process user instance state changes for each of the user's locations, as they occur. This ability may be significant, because a change in user instance state on one location may move the user from an acceptable to an unacceptable mode, or vice-versa.

In order to ensure sequential handling of the events, system 10 may maintain as many virtual queues as there are user instances across the servers.

User State Manager

Once system 10 determines the mode for each user, it can determine whether action is necessary with respect to any of the users and, if so, take such action. Responsibility for taking action against a user may lie with a user state manager 24 on each server. A user state manager may take corrective action based on one user instance, even if the user has user instances at multiple locations requiring action.

As stated above, global state managers may determine that action is necessary with respect to one or more locations for one or more users, depending upon the user modes determined by the global state managers. Global state managers 22 may transmit updated user modes to at least the respective user state managers 24 on servers hosting those locations.

User state manager 24 then may compare the user instance state with the user's preference for the location where action is indicated. For example, the user preference may be inactive for the first location, while the user has a preference to be active at one or more other locations. If the user's preference is to be inactive at one location—and not at all locations—user state manager 24 may transmit an initial warning to the user for a certain period of time. In one embodiment, the period of time may be fifteen seconds, although the time period also may be configurable. If the user does not change the user instance state at the impacted location, within the allotted time, so that the user is either all active mode or a universal inactive mode, a user state manager may remove the user instance from the impacted location.

In another aspect, a global state manager 22 may transmit all user modes to the user state managers 24 and not just those corresponding to users in the mixed-state mode. User state manager then may analyze each user mode but take no action if the user mode is determined to be either all active mode or a universal inactive mode. In the event that the system issued a warning to a user, who subsequently implemented a universal inactive mode, the user state manager 24 then may terminate this warning and not remove the user instance from the location in question.

In either aspect, user state manager 24 also may analyze recent user activity to ensure that a user is not attempting to bypass the rules, e.g., by switching to an active state after receiving a warning, then going inactive again without engaging in any activity. The system may permit the user to do this a predetermined number of times, e.g., three times, after which user state manager may remove the user instance automatically from the location.

Although system 10 may process user activity substantially in real time, the system also may include a built in delay in order to permit the user to resolve an inadvertent mixed-state mode designation. For example, in one embodiment, the system may build in a 3 second delay between user mode determination and delivery of a warning. This time delay may be configurable to either lengthen or shorten the delay.

The diagram of FIG. 2C further illustrates that each location events broadcaster 20 may include or be in communication with an event dispatcher 26. During peak usage a dispatcher may process approximately 2.7 million raw events per hour. For each type of event, a different dispatcher 26 may be implemented to optimize the processing or filtering actions associated with the specific event. For example, duplicate events may not affect a global state of a user. Thus, upon receiving an incoming event from a location via a location processor 28, the event dispatcher 26 may identify and filter out those events or other similar events that do not affect the global state of a user.

This pattern implementation also may build extensibility into system 10 so that the addition of a new event type may be handled by creating a new dispatcher, e.g., by adding a new entry to an event filter registry 30 and/or a desired course of action to an event handler registry 32. By building the logic into the event dispatcher 26, the system 10 may adapt flexibly to the new type without affecting other existing components.

The appropriate target global state manager for each event may be on a local server 12, 52 or a remote server. As such, as the events pass the above filters 33, event dispatcher 26 then may identify which global state manager 22 is the correct target to receive the user's event and then may transmit the event to that manager for further processing.

In FIG. 2D, it can be seen that a user state manager 24 may reside within a user state container 34 that also may include a plurality of user state change event handlers 36 in communication with an event receiver 38 and a serial executor 40.

State change event handlers 36 may encapsulate the event specific handling for the events submitted to user state manager 24. In addition to the standard activity processing events that may be received from a global state change event processor, event handlers 36 also may handle less frequent event occurrences, such as activity starts and user instances leaving locations.

Each player state manager 24 may include an action state decider 42 for determining what actions to take with respect to a user, given the user mode determined by global state manager 22 and a mixed-state executor 44 for implementing the action determined by state decider 42.

As discussed above, the system may be configured to apply certain corrective actions to a user at one or more locations depending on the user's mode as determined by the global state manager and depending on the current status of the related user instances at those locations.

In addition, state decider 42 should be configured with a rule set instructing state executor 44 to remove a user instance from a location due to an extended period of inactivity. This is implemented to ensure that a user does not occupy a location position for a long duration without any apparent intention to be active.

Inactivity counter 48 additionally or alternatively may be configured to record the number of times a user executes an active/inactive state change sequence, which may indicate an attempt to bypass the system warnings. In this configuration, if inactivity counter 48 records a predetermined or configurable number of consecutive active/inactive transactions without the user taking any substantive action, e.g., three transactions, the system may be configured to remove the user instance from the location.

Thread Implementation

The system may use threads extensively in one or more system components. Threads may permit asynchronous processing of both local and remote events, which may safeguard core activity by segregating it from user analysis activity. Thread implementation also may permit parallel processing by the multiple system servers, yielding higher throughput and faster turnaround time. For multiple processing cores, multiple threads are needed. If the threads are utilized properly, a system with N processing cores can achieve a throughput close to N times what can be done in a single threaded model.

Thread implementation may proceed in the following fashion, which is not excluded to, but may be illustrated best as it relates to the digital gaming example presented below:

A game-play thread may deposit location events in a queue, e.g., TableEventsQueue, and then proceed with its tasks without waiting for further implications of this event.

ThreadPoolExecutor implemented in location (table) events broadcaster 20 may obtain table events from this queue and proceed further. The system may implement a synchronization requirement for these threads at an individual table-user level, i.e., ThreadPoolExecutor should execute only one table-event per user per table at a time. Multiple events from the same user but on different tables, however, may be processed simultaneously.

The events may be filtered, e.g., to remove duplicate events or events that haven't changed from the last iteration and, after local processing by table events broadcaster 20 may be dispatched to the correct global sit out state manager 22 which may be selected based on the application of load balancing, as discussed above. These player events then may be submitted to another queue, e.g., GlobalEventsQueue.

Global sit out state manager 22 may implement a Thread Pool Executor and may retrieve user events from GlobalEventsQueue for further processing and filtering. Because global sit out state manager 22 is tasked with determining a user mode based on the totality of the user's activity, a synchronization requirement for these threads may be at individual user level, requiring that only one event per user across all tables should be executed at a time.

After this processing is completed, thread UserModeChangeEvent 50 that is seen in FIGS. 2A and 2B may be generated and sent to the user state modules. These UserModeChangeEvents then may be submitted to another queue, e.g., UserStateEventQueue.

A ThreadPoolexecutor implemented in Player State Container 34 may obtain UserModeChangeEvents 50 from this queue, i.e., UserStateEventQueue, and may execute further. At this stage, the system may require synchronization for these threads at an individual table-user level, i.e., for each user-occupied table, only one user state event should be executed at a time. As with ThreadPoolExecutor, multiple events from the same user but on different tables can be processed simultaneously.

### Example 1

Computer-Implemented Gaming Environment

In this example, locations may comprise virtual, digital gaming tables and users may be referred to as players. A strategic advantage may comprise a more experienced player sitting out at one or more tables while waiting for a less experienced player to appear, at which point the more experienced player may return to the table in an attempt to win funds from the less experienced player.

This example presents one manner in which the process flow may occur. Technical implementation may be supported by the detailed description presented above.

Sitting out from a game at one or more tables may be a normal, regularly occurring event not deserving of remedial action, however. For example, a user may need to take a break from a session and may wish to continue after some time. In this case, the user can choose to sit out from all tables immediately after completion of a current game or of all current games at which the user is seated (e.g., if the user is seated at four tables, two of which are active, the user may sit-out at one of the active tables when the current hand at that table finishes, continue playing at the other active table, and then sit out at that table—and therefore at all tables—when that second hand finishes). This wait may take a few seconds or a few minutes, depending on the level of activity of the active tables, and the system may recognize that the user should not be penalized during this time span.

Alternatively, a player may be seated at one or more tables where blinds, e.g. a small blind and a big blind, are contributed by a subset of the player at the table at each hand, i.e., each round. If the user seeking to sit out is not one of the players required to contribute a blind, the user can play pocket cards without a change in the amount of his or her funds if they initially appear worthwhile and then can sit out when it is the user's turn to contribute the big blind. As with the previous sit-out option, this feature can take effect once a big blind has been reached on any table or, preferably, it may take effect sequentially, such that the player is seated out at each respective table when the blind position is reached at that table.

Both of the above requirements give rise to a scenario where a genuine user would be playing on some tables and sitting-out on others, causing the system to potentially perceive the user as a suspect user. The system and method, however, should be able to identify and not attempt remedial action against those users. Thus, the system may be configured to segregate the actual, bad users from genuine, non-problematic users.

Regarding analyzing the user's current activity state, the system may include the option to “sit-out next hand” or “sit-out next big blind,” which each reflect a future preference to sit out at that table. If the user has either of these options selected, the system may classify that user as being in the “universal inactive mode.”

Conversely, not selecting either of these options (or any other kind of sit out option) may correlate to a future preference to sit in, i.e., to play actively at that table and may correspond to the user being classified in the “all active mode.”

In addition, “mixed-state mode” may correspond to the user indicating a preference to sit out at one or more tables while remaining active at one or more other tables.

In a digital gaming environment, multiple exceptions may exist that may trigger placing the user into a “watch” state. A non-exhaustive list of these exceptions may include one or more of:

(1) The user being the only entity seated at a table;

(2) The user having joined a table with a game already in progress, where the system requires the user to sit out and wait until a permitted entry point (e.g., the start of a new hand);

(3) The user having insufficient funds to continue playing. In this example, the system may leave the user at the table in a sitting-out state in order to permit the user to refill his or her account; and

(4) All other users on the table sitting out, such that the user could not play even if he or she wanted to.

As stated above regarding the system and method generally, determining whether to take action with respect to user activity may occur based on the user's current, actual state at each location. This implementation means that certain users identified as being in Mixed-State Mode may not face corrective action for tables at which they are scheduled to sit out but at which they currently are active. For example, a user that is playing at a first table and that has selected the “sit-out next hand” option at a second table but that is still part of the current game at that second table may not receive a warning or be removed from the table, even if the selected sit-out preference would mean that the user initially is identified as being in Mixed-State Mode

Regarding system structure, in addition to facilitating user game play, each table may maintain each seated user's current state with respect to the hand currently being played, e.g., “sit-in,” i.e., part of the current hand, or “sit-out,” i.e., not part of the current hand.

Note that users may be considered to be “sitting-in” if they have seen their cards at any point during the hand; thus, users that have folded and are not currently active in the hand still are considered to be “sitting in.”

State decider 42 may apply the following logic in determining what action, if any, to take against a user:

If the Player Mode as determined by global state manager 22 is Mixed-State Mode and current status of the player on this table is Sit-Out, issue an initial warning for a predetermined or configurable amount of time, e.g., about 15 seconds, which may be tracked using timer 46. If, within that time, player status on that table changes to Sit-In, cancel the warning. Alternatively, if the player does not change to a Sit-In mode within the time amount, kick-out the player from the table and change the player's state to “Mixed-State Kick-Out” (MSKO state).

If the Player Mode is Play Mode, do not kick-out the player and, if necessary, change the player's state to “No Kick-Out” (NKO state). In the event that the player was scheduled to be kicked out earlier, the state decider 42 should cancel this kick-out action.

If the Player Mode is Universal Sit-Out Mode, do not kick-out the player at this point. In the event that the player was scheduled to be kicked out earlier, the state decider 42 should cancel this kick-out action.

In this example, the inactivity counter may be a sit out counter that keeps track of the number of consecutive hands that the user sits out at a given table. The sit out (inactivity) counter 48 may be configured to increment with each consecutive hand that the user is inactive. Then, state executor 44 may be instructed to kick the player out if the does not return to the table within a configurable or predetermined number of hands. For example, sit out counter may be set to trigger state executor if the player sits out between about 3 and about 100 hands, preferably between about 10 and about 70 hands, still more preferably between about 15 hands and about 40 hands, and in one embodiment, about 25 hands. In the event this occurs, kick out state decider 42 may modify the player's state to “Regular Kick-out” (RKO).

### Example 2

Computer-Implemented Trading Environment

This example presents a second manner in which the process flow may occur. Again, technical implementation may be supported by the detailed description presented above.

The current system and method also may be adapted to a digital trading environment in which multiple users can be present in multiple virtual locations, e.g., trading desks. In this example, system administrators may not want users to take seats at multiple desks—because seating may be at a premium or for any other reason—and not be active at all of those seats. The same methodology as described above may apply in this scenario, with the system transmitting a warning and, if no remedial action is taken within a predetermined time, removing the user from the inactive position(s).

While the foregoing written description of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

What is claimed is:

1. A method for optimizing and distributing user activity data processing in a multi-user, multi-location digital environment, comprising:
hosting a plurality of virtual locations;
identifying for each user, locations where they have initiated a user instance;
determining, for each user, a user instance state at each location;
transmitting the user instance states via at least one location events broadcaster to at least one of a plurality of global state managers hosted on at least one of the servers;
optimizing and distributing the user instance states data load among at least two servers;
compiling and analyzing, by the at least one of a plurality of global state managers, the user instance states to determine which users are mixed-state mode, wherein mixed-state users have an active user instance at a first location and an inactive user instance at a second location;
delivering an identification of the mixed-state users and one or more locations of their inactive user instances to the servers hosting those locations;
determining if any exception exists that would suspend action against any one or more of the mixed-state users; and
taking action with respect to the mixed-state users for which there is no exception.

2. The method of claim 1, wherein each of the user instance states in the compiling and analyzing step is analyzed with regard to a user's indication of a future user instance state preference for one or more locations.

3. The method of claim 1, further comprising comparing each user instance state in the determining a user instance state step with a cached user state, wherein the transmitting step comprises transmitting only those user instance states that are different than the cached user states.

4. The method of claim 3, wherein the reduced transmission of user instance states results in an increase in total system capacity of up to about 80%.

5. The method of claim 1, further comprising balancing analysis of the user instance states among the plurality of global state managers.

6. The method of claim 5, wherein the balancing step further comprises routing user instance states for a user to a server that is hosting at least one location where the user instance is present.

7. The method of claim 1, wherein the determining, compiling and analyzing, and optimizing and distributing steps are implemented using threads in an asynchronous processing environment.

8. The method of claim 1, wherein action comprises transmitting a warning to a mixed-state user to remedy the mixed-state status.

9. The method of claim 1, wherein action comprises removing a mixed-state user from the second location.

10. The method of claim 1, wherein the multi-user, multi-location digital environment can include up to about 2.7 million raw events per hour.

11. The method of claim 1, wherein the multi-user, multi-location digital environment can include up to about 3,000 locations with at least about 6,000 concurrent user instances.

12. The method of claim 1, wherein the global state managers are horizontally scalable to each additional server beyond the first.

13. The method of claim 1, wherein the location events broadcaster removes duplicate or unchanged events before transmitting the data to a global state manager.

14. The method of claim 1, wherein the user instance states in the transmitting step are further processed by the location events broadcaster including
filtering user events for the event dispatcher;
determining which global state manager is the desired target to receive the user events; and
transmitting the user events through the location events broadcaster to the target global state manager.

15. The method of claim 14, wherein the location events broadcaster does not transmit the user events that do not change a global state of the user.

16. A computer-implemented system for optimizing and distributing user activity data processing in a multi-user, multi-location digital environment, comprising:
one or more servers for storing user state and user event data;
a user state manager for executing the end decision to keep or remove a user instance from a location including
a state decider for determining what actions to take with respect to the user instance; and
a state executor for implementing the action determined by the state decider;
a location events broadcaster for aggregating data for transmission to other system components; and
one or more global state managers for consolidating user instances' states across all locations, for analyzing those states by using a global state calculator to determine a user mode, and for implementing a global state filter in order to minimize or eliminate unnecessary transmissions.

17. The system of claim 16, wherein the one or more servers can process up to about 2.7 million raw events per hour.

18. The system of claim 16, wherein the multi-user, multi-location digital environment can include up to about 3,000 locations with at least about 6,000 concurrent user instances.

19. The system of claim 16, wherein the global state managers are horizontally scalable to each additional server beyond the first.
